(19) United States
(12) Patent Application Publication
(10) Pub. No.: US 2026/0016062 A1
(43) Pub. Date: Jan. 15, 2026

(54) ELECTRIC BRAKING DEVICE

(71) Applicant: ADVICS CO., LTD., Kariya-shi, Aichi-ken (JP)

(72) Inventor: Satoshi HIRATA, Kariya-shi, Aichi-ken (JP)

(73) Assignee: ADVICS CO., LTD., Kariya-shi, Aichi-ken (JP)

(21) Appl. No.: 18/992,593

(22) PCT Filed: Aug. 3, 2023
(86) PCT No.: PCT/JP2023/028377

§ 371 Date: Jan. 9, 2025

(30) Foreign Application Priority Data
Aug. 3, 2022 (JP) 2022-123976

(51) Int. Cl. F16D 65/18; B60T 13/74; F16D 55/226; F16D 121/24; F16D 125/40; F16D 125/48; F16D 127/06

(52) U.S. Cl. CPC F16D 65/18; B60T 13/746; F16D 55/226; F16D 2121/24; F16D 2125/40; F16D 2125/48; F16D 2127/06

(57) ABSTRACT

An electric braking device includes a transmission mechanism that transmits rotation of a motor shaft member in an electric motor. The electric braking device includes an actuator section that applies a braking force to a wheel by pressing a friction member against a rotary body. The actuator section moves the friction member in response to rotation of the electric motor transmitted by the transmission mechanism. The electric braking device includes a rotation stop mechanism that stops rotation in a direction of reducing the braking force among rotational directions of the electric motor. The electric braking device includes a motor bracket 81 as a member to which the electric motor is attached. The rotation stop mechanism is further attached to the motor bracket.

### TECHNICAL FIELD

The present disclosure relates to an electric braking device.

### BACKGROUND ART

An electric braking device in which a motor and a ratchet unit are fixed to the same housing is disclosed in PTL 1.

### CITATION LIST

### Patent Literature

PTL 1: KR-A-10-2021-0004895

### SUMMARY

### Technical Problem

In the case where the motor and the ratchet unit are attached to the housing as in the electric braking device disclosed in PTL 1, attachment accuracy of each thereof to the housing is required. There is room for improvement in efficiency of assembling work of the electric braking device.

### Solution to Problem

An electric braking device for solving the above problem includes: a transmission mechanism that transmits rotation of a motor shaft member in an electric motor; an actuator section that moves a friction member in response to rotation of the electric motor transmitted by the transmission mechanism, presses the friction member against a rotary body that rotates together with a wheel, and thereby applies a braking force to the wheel; a rotation stop mechanism that stops rotation in a direction of reducing the braking force among rotational directions of the electric motor when meshing with a rotational section that rotates together with the motor shaft member; and a motor bracket as a member to which the electric motor is attached, and the gist thereof is that the rotation stop mechanism is further attached to the motor bracket.

According to the above configuration, as a unit in which the electric motor, the rotation stop mechanism, and the motor bracket are integrated, the electric motor and the rotation stop mechanism can be attached. Thus, a position of the electric motor and a position of the rotation stop mechanism can be defined by the motor bracket. That is, positioning accuracy between two each of the electric motor, the rotation stop mechanism, and the rotational section can be ensured by attaching the above unit.

### BRIEF DESCRIPTION OF DRAWINGS

FIG. 1 is a partial cross-sectional view illustrating an embodiment of an electric braking device.

FIG. 2 is a partial cross-sectional view illustrating the electric braking device.

FIG. 3 is a view illustrating an electric motor, a rotation stop mechanism, and a motor bracket in the electric braking device.

FIG. 4 is a front view illustrating the motor bracket provided to the electric braking device.

FIG. 5 is a view illustrating a state where the electric braking device is disassembled.

FIG. 6 is a view illustrating a motor bracket provided to an electric braking device in a modified example.

### DESCRIPTION OF EMBODIMENTS

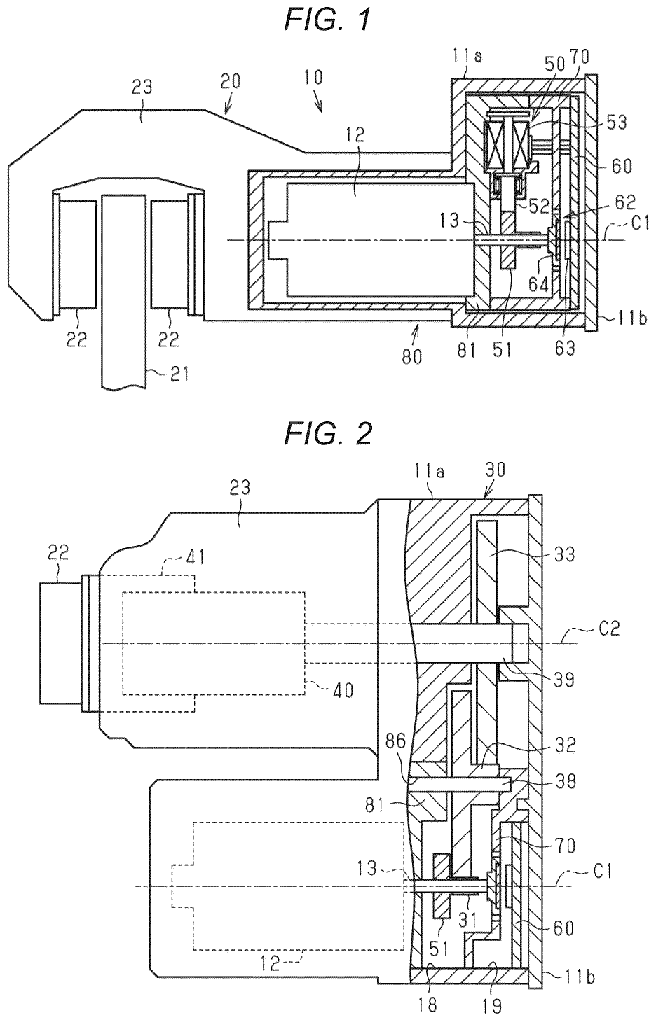

A description will hereinafter be made on an embodiment of an electric braking device with reference to FIG. 1 to FIG. 5.

### Electric Braking Device

An electric braking device 10 includes an actuator section 20 that applies a braking force to a wheel by pressing a friction member 22 against a rotary body 21 that rotates together with the wheel. The electric braking device 10 includes a transmission mechanism 30 that transmits rotation of a motor shaft member 13 in an electric motor 12. The actuator section 20 moves the friction member 22 in response to rotation of the electric motor 12 transmitted by the transmission mechanism 30.

The electric braking device 10 includes a rotation stop mechanism 50 that stops rotation in a direction of reducing the braking force among rotational directions of the electric motor 12 when meshing with a rotational section that rotates together with the motor shaft member 13.

The electric braking device 10 includes a motor bracket 81 as a member to which the electric motor 12 is attached. The rotation stop mechanism 50 is further attached to the motor bracket 81.

FIG. 1 and FIG. 2 each illustrate the electric braking device 10. The electric braking device 10 includes a case 11a, a cover 11b, and a caliper housing 23. The cover 11b closes an opening of the case 11a. The caliper housing 23 is attached to the case 11a. The case 11a is sealed.

The electric braking device 10 includes the actuator section 20. As illustrated in FIG. 1, the actuator section 20 includes the friction member 22 that can be pressed against the rotary body 21 rotating together with the wheel of a vehicle. The rotary body 21 is a brake disc, for example. The actuator section 20 can generate the larger braking force as a force that presses the friction member 22 against the rotary body 21 is increased.

The electric braking device 10 includes the electric motor 12. In FIG. 1 and FIG. 2, a line along an axis of the motor shaft member 13 in the electric motor 12 is illustrated as an input axis C1.

As illustrated in FIG. 2, the actuator section 20 includes a conversion mechanism 40 that converts rotary motion of the electric motor 12 into linear motion. The conversion mechanism 40 is a feed screw that is configured by a screw shaft and a nut, for example. The actuator section 20 includes a piston 41, and the friction member 22 is attached to an end portion thereof toward the rotary body 21. The conversion mechanism 40 and the piston 41 are housed in the caliper housing 23. The actuator section 20 can move the piston 41, that is, the friction member 22 by the linear motion, into which the rotary motion of the electric motor 12 is converted by the conversion mechanism 40. One of directions in which the piston 41 is moved by the linear motion is a direction in which the friction member 22 attached to the piston 41 is brought closer to the rotary body 21. The other of the directions in which the piston 41 is moved by the linear motion is a direction in which the friction member 22 attached to the piston 41 is moved away from the rotary body 21.

As illustrated in FIG. 2, the actuator section 20 includes the transmission mechanism 30 that transmits the rotary motion of the electric motor 12 to the conversion mechanism 40. The transmission mechanism 30 may include a speed reduction mechanism. An example of the transmission mechanism 30 will be described.

The transmission mechanism 30 is configured by a combination of a gear and the like. The transmission mechanism 30 includes an input gear 31. For example, the input gear 31 is attached to the motor shaft member 13. The input gear 31 may be configured by forming teeth on a surface of the motor shaft member 13. The transmission mechanism 30 includes an output gear 33. The transmission mechanism 30 includes an output shaft member 39. The output gear 33 is attached to the output shaft member 39. In FIG. 2, a line along an axis of the output shaft member 39 is illustrated as an output axis C2. An example of the transmission mechanism 30 is configured that the output axis C2 is positioned in parallel to the input axis C1.

The transmission mechanism 30 may include an intermediate gear 32. The transmission mechanism 30 may include an intermediate shaft member 38, to which the intermediate gear 32 is attached. For example, the intermediate gear 32 includes: a first gear section that can mesh with the input gear 31; and a second gear section that can mesh with the output gear 33. In the intermediate gear 32, the first gear section and the second gear section rotate together. In an example of the intermediate gear 32, as illustrated in FIG. 2, the first gear section and the second gear section are molded as one unit. For example, the transmission mechanism 30 may include a first intermediate gear and a second intermediate gear as separate members. The first intermediate gear corresponds to the first gear section that can mesh with the input gear 31, and the second intermediate gear corresponds to the second gear section that can mesh with the output gear 33. A plurality of the intermediate gears may be attached to the intermediate shaft member 38.

In the transmission mechanism 30, the rotation of the motor shaft member 13 is input to the input gear 31. The output gear 33 can rotate in response to rotation of the input gear 31. The output gear 33 transmits rotation to the actuator section 20 via the output shaft member 39. More specifically, since the input gear 31 and the first gear section of the intermediate gear 32 mesh with each other, the rotary motion of the electric motor 12 can be transmitted from the motor shaft member 13 to the intermediate shaft member 38. Then, since the second gear section of the intermediate gear 32 and the output gear 33 mesh with each other, the rotary motion of the electric motor 12 can be transmitted from the intermediate shaft member 38 to the output shaft member 39. The output shaft member 39 is coupled to the conversion mechanism 40. When the output gear 33 causes the output shaft member 39 to rotate, the rotary motion is transmitted to the conversion mechanism 40.

In FIG. 2, the single intermediate gear 32 exemplified. However, as the transmission mechanism 30, plural gears, each of which contributes to transmission of the rotary motion, may be interposed between the input gear 31 and the output gear 33.

As illustrated in FIG. 1, the electric braking device 10 includes the rotation stop mechanism 50. The rotation stop mechanism 50 can maintain the braking force that is applied by the actuator section 20. For example, a parking brake function can be implemented by operating the rotation stop mechanism 50. The rotation stop mechanism 50 includes, for example, a solenoid section 53 and an engagement section 52 that can be moved by the solenoid section 53.

The electric braking device 10 includes the motor bracket 81. The electric motor 12 and the rotation stop mechanism 50 are attached to the motor bracket 81. The motor bracket 81 is fixed to the case 11a. That is, the electric motor 12 is fixed via the motor bracket 81. In addition, the rotation stop mechanism 50 is fixed via the motor bracket 81. In the electric braking device 10, the electric motor 12 and the rotation stop mechanism 50 are integrated by the motor bracket 81 to constitute a parking brake unit 80. The parking brake unit 80 is housed in the case 11a.

The electric braking device 10 may include a circuit section 60. The circuit section 60 has a processing circuit that controls the rotary motion of the electric motor 12. The circuit section 60 includes a circuit board and mounted components that are mounted on the circuit board. For example, the circuit section 60 is housed in the case 11a. FIG. 1 and FIG. 2 each illustrate an example in which the circuit section 60 is attached such that the input axis C1, which is the line along the axis of the motor shaft member 13, intersects the circuit section 60. More specifically, the circuit section 60 is arranged such that the input axis C1 and the circuit board are orthogonal to each other.

The electric braking device 10 may include a rotation angle sensor 62 for detecting a rotation angle of the motor shaft member 13. An example of the rotation angle sensor 62 is a non-contact sensor. FIG. 1 and FIG. 2 each exemplify the rotation angle sensor 62 that is configured by a sensor element 63 and a magnet 64 as a detected section. The sensor element 63 is mounted on the circuit board. The magnet 64 is attached to the motor shaft member 13. The sensor element 63 is arranged at a position opposing the magnet 64.

The electric braking device 10 may include a partition wall 70 in the case 11a. For example, in the case 11a, the partition wall 70 can define a housing section for housing the circuit section 60. More specifically, the partition wall 70 can define a first housing section 18, in which the electric motor 12 is housed, and a second housing section 19, in which the circuit section 60 is housed. The transmission mechanism 30 may be housed in the first housing section 18. The solenoid section 53 of the rotation stop mechanism 50 may be housed in the first housing section 18.

The partition wall 70 may be formed with a through-hole. The first housing section 18 and the second housing section 19 are connected by the through-hole. For example, the partition wall 70 may include a through-hole for arranging the magnet 64 of the rotation angle sensor 62 in the hole. Preferably, a diameter of the through-hole is slightly larger than a diameter of the magnet 64 so as to reduce a clearance between the through-hole and the magnet 64.

### Rotation Stop Mechanism

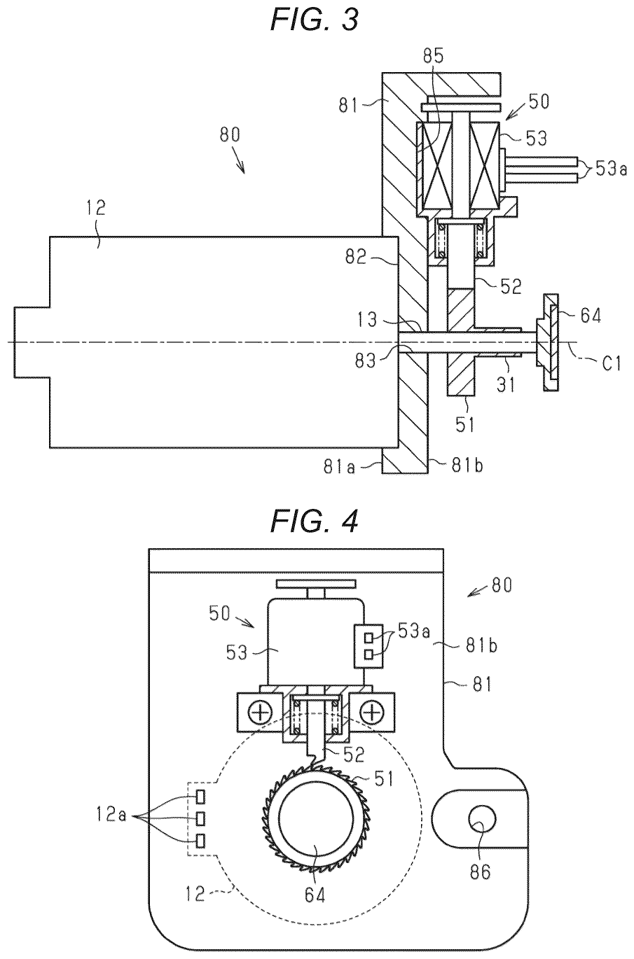

An example of the rotation stop mechanism 50 functions as a ratchet mechanism. As illustrated in FIG. 3 and FIG. 4, the electric braking device 10 includes a ratchet gear 51 that is attached to the motor shaft member 13. Together with the ratchet gear 51, the rotation stop mechanism 50 constitutes the ratchet mechanism. The ratchet gear 51 is an example of the rotational section that rotates together with the motor shaft member 13. For example, the ratchet gear 51 is molded together with the input gear 31. As another example, the ratchet gear 51 may be attached to the motor shaft member 13 as a different member from the input gear 31. Alternatively, the ratchet gear 51 may be attached to a position that is closer to the electric motor 12 than the input gear 31, or the input gear 31 may be attached to a position that is closer to the electric motor 12 than the ratchet gear 51. The engagement section 52 provided to the rotation stop mechanism 50 has a claw shape that meshes with teeth of the ratchet gear 51. The solenoid section 53 provided to the rotation stop mechanism 50 can cause the engagement section 52 to mesh with the ratchet gear 51. More specifically, the solenoid section 53 moves the engagement section 52 in a direction to approach the ratchet gear 51 when a current is applied to a coil. When the engagement section 52 that has come into contact with the ratchet gear 51 meshes with the teeth of the ratchet gear 51, rotation of the ratchet gear 51 is stopped. By stopping the rotation of the ratchet gear 51, the rotation stop mechanism 50 can stop rotation of the electric motor 12. The rotation stop mechanism 50 can stop the rotation in the direction of reducing the braking force among the rotational directions of the electric motor 12. In this way, the rotation stop mechanism 50 can maintain the braking force that is applied to the wheel by the actuator section 20. Meanwhile, the rotation stop mechanism 50 can allow the rotation in a direction of increasing the braking force among the rotational directions of the electric motor 12. The rotation stop mechanism 50 can cancel the maintenance of the braking force by releasing meshing between the engagement section 52 and the ratchet gear 51.

The solenoid section 53 includes a solenoid terminal 53a. The solenoid terminal 53a is connected to the circuit section 60, for example. The solenoid terminal 53a is inserted through a through-hole for a terminal, which is formed in the partition wall 70, for example, and is thereby connected to the circuit section 60 through the partition wall 70. As another example, the solenoid terminal 53a may be connected to the circuit section 60 via a connector and a wire, or the like. A path that connects the solenoid terminal 53a and the circuit section 60 is not limited to one that penetrates the partition wall 70, and may bypass the partition wall 70.

### Motor Bracket

The motor bracket 81 includes a fixed section that is a component to be fixed to the case 11a and is shaped to correspond to the case 11a.

As illustrated in FIG. 3, the motor bracket 81 includes a motor attachment section 82 for attaching the electric motor 12. An end surface of the electric motor 12, from which the motor shaft member 13 protrudes, is attached to the motor attachment section 82.

The motor bracket 81 as an example has a flat plate shape. In the motor bracket 81, a surface provided with the motor attachment section 82 is a first surface 81a. In the motor bracket 81, a surface on an opposite side from the first surface 81a is a second surface 81b.

As illustrated in FIG. 3, the motor attachment section 82 is formed with a rotational shaft hole 83 as a through-hole. The motor shaft member 13 is inserted through the rotational shaft hole 83. By being inserted through the rotational shaft hole 83, the motor shaft member 13 penetrates the motor bracket 81 and protrudes from the second surface 81b. The input gear 31 and the ratchet gear 51 are attached to a portion of the motor shaft member 13 that protrudes from the second surface 81b. That is, the electric motor 12, the motor bracket 81, the ratchet gear 51, and the input gear 31 are sequentially arranged along the axis of the motor shaft member 13.

The motor bracket 81 may include a terminal hole as a through-hole. As illustrated in FIG. 4, a motor terminal 12a that is provided to the electric motor 12 can be inserted through the terminal hole. Through the terminal hole, the motor terminal 12a can be used from a second surface 81b side. For example, the motor terminal 12a can be connected to the circuit section 60 via a connector and a wire, or the like. As another example, the motor terminal 12a may be inserted through a through-hole for a terminal, which is formed in the partition wall 70, and may thereby be connected to the circuit section 60 through the partition wall 70.

As illustrated in FIG. 3 and FIG. 4, the motor bracket 81 includes a solenoid attachment section 85 for attaching the solenoid section 53 in the rotation stop mechanism 50. The solenoid attachment section 85 is provided to the second surface 81b of the motor bracket 81. The solenoid section 53 is attached to the solenoid attachment section 85 such that the engagement section 52 can protrude toward the ratchet gear 51. Just as described, the rotation stop mechanism 50 is arranged on an opposite side of the motor bracket 81 from the electric motor 12.

As illustrated in FIG. 4, the motor bracket 81 may include a transmission shaft hole 86 as a through-hole. A shaft member that is provided to the transmission mechanism 30 can be inserted through the transmission shaft hole 86. For example, as illustrated in FIG. 2, the intermediate shaft member 38 can be inserted through the transmission shaft hole 86.

### Parking Brake Unit

The parking brake unit 80 is covered with the case 11a and the cover 11b. That is, the electric motor 12 is covered with the case 11a and the cover 11b. In addition, the rotation stop mechanism 50 is covered with the case 11a and the cover 11b. The parking brake unit 80 is attached to the case 11a such that the rotation stop mechanism 50 faces the opening of the case 11a.

### Manufacturing Method for Electric Braking Device

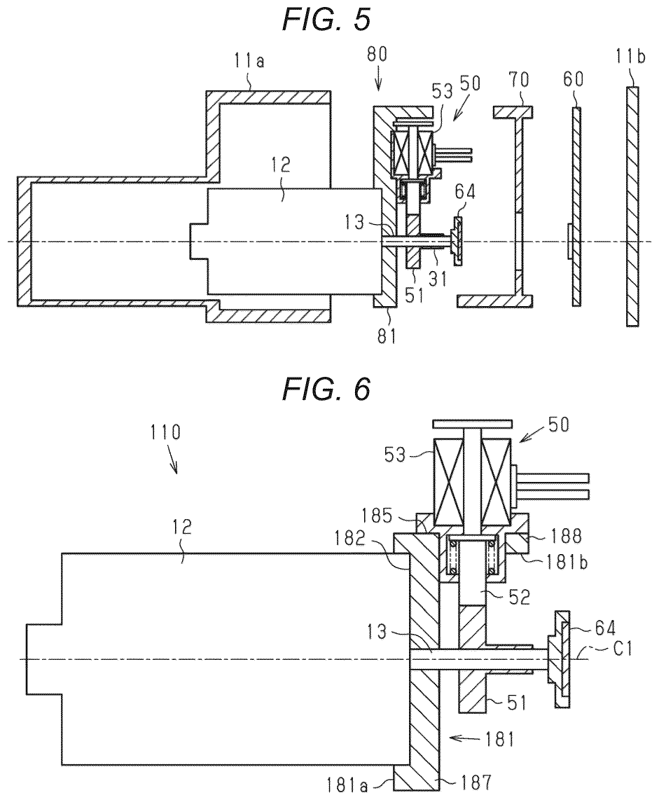

In a manufacturing method for the electric braking device 10, first, a step of assembling the parking brake unit 80 is performed. Next, as illustrated in FIG. 5, a step of attaching the parking brake unit 80 to the case 11a is performed.

A specific description will be made on an example of the manufacturing method for the electric braking device 10. First, a step of attaching the electric motor 12 to the motor bracket 81 is performed. Next, a step of attaching the ratchet gear 51, the input gear 31, and the magnet 64 to the motor shaft member 13 is performed. Then, a step of attaching the rotation stop mechanism 50 to the motor bracket 81 is performed. After the above steps, the parking brake unit 80, in which the electric motor 12, the rotation stop mechanism 50, and the motor bracket 81 are integrated, is assembled. Next, a step of attaching the parking brake unit 80, in which the electric motor 12, the rotation stop mechanism 50, and the motor bracket 81 are integrated, to the case 11a is performed. For example, the parking brake unit 80 is attached to the case 11a by inserting the electric motor 12 through the opening of the case 11a from an end surface on an opposite side of the electric motor 12 from the end surface, from which the motor shaft member 13 protrudes. Then, after the transmission mechanism 30, the partition wall 70, and the circuit section 60 are attached to the case 11a, the cover 11b is attached to the case 11a to close the opening of the case 11a. By inserting the intermediate shaft member 38 of the transmission mechanism 30 through the transmission shaft hole 86, the intermediate shaft member 38 can be supported by the motor bracket 81.

### Operation and Effects

A description will be made on operation and effects of this embodiment.

According to the electric braking device 10, as the parking brake unit 80, in which the electric motor 12, the solenoid section 53 of the rotation stop mechanism 50, and the motor bracket 81 are integrated, the electric motor 12 and the rotation stop mechanism 50 can be attached. In this way, the position of the electric motor 12 and the position of the rotation stop mechanism 50 can be defined by the motor bracket 81. That is, positioning accuracy between two each of the electric motor 12, the rotation stop mechanism 50, and the ratchet gear 51 as the rotational section can be ensured by attaching the parking brake unit 80. In this way, it is possible to improve efficiency of assembling work of the electric braking device 10.

In the electric braking device 10, the positioning accuracy between the electric motor 12 and the rotation stop mechanism 50 can be ensured.

According to the electric braking device 10, the following effects can be obtained by changing specifications of the case 11a while specifications of the electric motor 12 are in common and specifications of the rotation stop mechanism 50 are in common, for example. When only the fixed section to the case 11a is changed in the motor bracket 81, the above electric motor 12 and the above rotation stop mechanism 50 can be attached to the case 11a with the different specifications. That is, there is no need to change the motor attachment section 82 and the solenoid attachment section 85 in the motor bracket 81, and it is possible to conform to the case 11a with the different specifications by changing the fixed section.

In the electric braking device 10, since the intermediate shaft member 38 is inserted through the transmission shaft hole 86 of the motor bracket 81, it is possible to ensure positioning accuracy between the intermediate shaft member 38 and the electric motor 12, which is attached to the motor bracket 81.

In the electric braking device 10, the rotation stop mechanism 50 is arranged on the opposite side of the motor bracket 81 from the electric motor 12. Since the motor bracket 81 is sandwiched, it is possible to expand a range where the electric motor 12 and the rotation stop mechanism 50 can be arranged without interfering the electric motor 12 and the rotation stop mechanism 50 with each other. That is, there are degrees of freedom in the arrangement of the electric motor 12 and the arrangement of the rotation stop mechanism 50. In this way, the electric motor 12 and the rotation stop mechanism 50 can be arranged easily to downsize the electric braking device 10.

In the electric braking device 10, the parking brake unit 80 is covered with the case 11a and the cover 11b. In this way, it is possible to obtain a waterproofing effect and a dustproofing effect for the electric motor 12 and the rotation stop mechanism 50. That is, it is possible to obtain the waterproofing effect and the dustproofing effect without covering the electric motor 12 and the rotation stop mechanism 50 separately. In addition, corrosion resistance of the electric motor 12 and the rotation stop mechanism 50 is improved by the waterproofing effect and the dustproofing effect.

In the manufacturing method for the electric braking device 10, the parking brake unit 80, in which the electric motor 12 and the rotation stop mechanism 50 are integrated, is attached to the case 11a. In this way, compared to a case where the electric motor 12 is attached to the case 11a and then the rotation stop mechanism 50 is further attached to the case 11a, attachment work of the electric motor 12 and the rotation stop mechanism 50 is facilitated.

### Modified Examples

This embodiment can be modified and implemented as follows. This embodiment and each of the following modified examples can be implemented in combination with each other unless technically contradictory.
In the above embodiment, the motor bracket 81 in the flat plate shape is exemplified. The shape of the motor bracket 81 is not limited thereto.

An electric braking device 110 illustrated in FIG. 6 includes a motor bracket 181 that is bent in an L-shape. The motor bracket 181 is bent such that a second surface 181b is located on an inner side. Being bordered by a bent portion of the motor bracket 181, one wall is designated as a first wall 187 and the other wall is designated as a second wall 188.

A motor attachment section 182 is provided to the first wall 187. The motor attachment section 182 is provided to a first surface 181a. A solenoid attachment section 185 is provided to the second wall 188. For example, the solenoid attachment section 185 includes a through-hole through which the engagement section 52 can pass. FIG. 6 exemplifies the rotation stop mechanism 50 arranged such that the solenoid section 53 is attached to the first surface 181a and the engagement section 52 protrudes from the second surface 181b.

That is, in the electric braking device 110, the electric motor 12 is attached to the first wall 187. In the electric braking device 110, the solenoid section 53 is attached to the second wall 188.
In the above embodiment, the configuration is exemplified that the electric motor 12 is attached to the first surface 81a of the motor bracket 81 and the solenoid section 53 is attached to the second surface 81b. The disclosure is not limited thereto. Both of the electric motor 12 and the solenoid section 53 may be attached to one of the surfaces of the motor bracket. For example, as in the electric braking device 110 illustrated in FIG. 6, both of the electric motor 12 and the solenoid section 53 may be attached to the first surface 181a of the motor bracket 181.
In the above embodiment, as the rotation stop mechanism 50, the mechanism of stopping the rotation of the electric motor 12 by meshing with the ratchet gear 51 as the rotational section is exemplified. The rotation stop mechanism is not limited thereto. For example, such a mechanism may be adopted that stops rotation of a rotor of the electric motor 12 by causing a columnar engagement section, which can protrude toward the rotor, to mesh with a hole formed in the rotor. In this case, the rotor of the electric motor 12 corresponds to the rotational section that rotates together with the motor shaft member 13. The engagement section can be moved by a solenoid, for example. For example, the above mechanism can be attached to a back surface of the motor bracket in the flat plate shape, in which the electric motor 12 is attached to a front surface. In this case, a through-hole, through which the engagement section can pass, is formed in the motor bracket in advance. In this way, the engagement section that has penetrated the motor bracket can mesh with the rotor.

### Technical Idea

The technical idea that can be grasped from the embodiment and the modified examples described above will be described.

[A] Together with the rotational section, the rotation stop mechanism constitutes the ratchet mechanism,
the rotational section is a ratchet gear that is attached to the motor shaft member,
the motor bracket is formed with the through-hole, through which the motor shaft member is inserted, and
the electric motor, the motor bracket, and the ratchet gear are sequentially arranged along the axis of the motor shaft member.

1. An electric braking device comprising:
a transmission mechanism that transmits rotation of a motor shaft member in an electric motor;
an actuator section that moves a friction member in response to rotation of the electric motor transmitted by the transmission mechanism, presses the friction member against a rotary body that rotates together with a wheel, and thereby applies a braking force to the wheel;
a rotation stop mechanism that stops rotation in a direction of reducing the braking force among rotational directions of the electric motor when meshing with a rotational section that rotates together with the motor shaft member; and
a motor bracket as a member to which the electric motor is attached, wherein
the rotation stop mechanism is further attached to the motor bracket.

2. The electric braking device according to claim 1, wherein
the rotation stop mechanism is arranged on an opposite side of the motor bracket from the electric motor.

3. The electric braking device according to claim 1 er-2, further comprising:
a case that covers the electric motor, the rotation stop mechanism, and the motor bracket.

4. The electric braking device according to claim 1, further comprising:
a case that covers the electric motor, the rotation stop mechanism, and the motor bracket.
